(19) United States
(12) Patent Application Publication
(10) Pub. No.: US 2009/0190367 A1
(43) Pub. Date: Jul. 30, 2009

(54) UNPLUGGED NIGHT LIGHTS

(76) Inventor: Haw-Hui CHU, Tanzih Township (TW)

Correspondence Address: SINORICA, LLC, 2275 Research Blvd., Suite 500, ROCKVILLE, MD, 20850, US

(21) Appl. No.: 12/021,841

(22) Filed: Jan. 29, 2008

(51) Int. Cl. F21L 4/00; B60Q 1/00

(52) U.S. Cl. 362/487; 362/183; 315/77

(57) ABSTRACT

The unplugged night lights, mainly comprises a base made of a soft material, a light-emitting device, a housing wrapping around the light-emitting device, and a thin-film solar cell pack. The light-emitting device is provided on the base, of which one terminal is connected to the thin-film solar cell pack. An electric energy transformed by the thin-film solar cell pack is thereby stored and supplied to the light-emitting device to give out a light source. A bottom of the base is coated with an adhesive layer to make the lamp directly adhere to the body of vehicle. Thus, it is easy to install the unplug night lamp and meets the goals of environmental protection and energy saving.

### BACKGROUND OF THE INVENTION

1. Field of the Invention

This invention is related to the night lights and particularly to an unplugged night lights powered with solar energy.

2. Description of Related Art

Along with progressive technology, everything in the modern life is more and more convenient for people, so these devices consume electric power seriously. However, the source of energy in the world will be exhausted and insufficient eventually; especially, the price of internationally crude oil currently rises day by day, so an energy source substitute is quite important and thus the solar energy is taken more and more seriously in its role, thereby solar cells of single crystal silicon, poly crystal silicon, and amorphous silicon being developed. Further, only the original attention, warning or indication lights may be used in vehicles running in the night to give attention signals; but due to the reason that the original attention night lights are not sufficient, vehicle drivers usually add several attention night lights onto the bodies of vehicles to highlight, in which a wire connected to one terminal of the attention night lights is electrically connected to a battery jar of the vehicle to drive the attention night lights to give out more address for the effect of attention.

Consequently, because of the technical defects of described above, the applicant keeps on carving unflaggingly through wholehearted experience and research to develop the present invention, which can effectively improve the defects described above.

### SUMMARY OF THE INVENTION

However, a conventional solar cell is generally made from single crystal silicon or poly-crystal silicon. Although the solar cell mades from the single crystal silicon or poly-crystal silicon may transform more than one time of solar energy into electric energy than the solar cell made from the amorphous silicon does, the solar cell mades from the single crystal silicon or poly-crystal silicon is much more expensive by two or three times in price than the solar cell made from the amorphous silicon is and is limited a lot in installation, and on a cloudy day, the efficiency if electric energy generated by the solar cell made from amorphous silicon is instead similar to that generated by the solar cell made from the single crystal silicon or poly-crystal silicon. Besides, the attention night lights is generally secured onto the body of vehicle and then electrically connected to the battery jar with electric wires. Thus, the construction is not convenient and the service life of battery jar is reduced. In order to solve the issues mentioned above, it is thereby necessary that the solar cell made from amorphous silicon is combined with the attention night lights.

An unplugged night lights according to this invention mainly consisits of a base made of a soft material, a light-emitting device, a housing wrapping around the light-emitting device, and a thin-film solar cell pack. The light-emitting device is provided on the base, mainly including a PCB on which a control circuit unit, a power source unit, and a light-emitting source are provided. One terminal of the control circuit unit is connected to the light-emitting source to control, and the other terminal of the control circuit unit is connected to the power source unit to supply electric energy to the light-emitting source and deposit the electric energy inputted by the thin-film solar cell pack.

The unplugged night lights according to this invention is provided with a flexible base, and a bottom of the base is thereby coated with an adhesive layer to directly adhere to the body of vehicle, and the thin-film solar cell pack is used to transform an external light source into the electric energy and store it, further supplying the electric energy to the light-emitting source. Thus, it is easy to install the unplugged night lights and meets the goals of environmental protection and energy saving.

### BRIEF DESCRIPTION OF THE DRAWINGS

FIG. 1 is a 3D view of a preferred embodiment of this invention;

FIG. 2 is a sectional view of the preferred embodiment of this invention;

FIG. 3 is a circuit block diagram of a preferred embodiment of this invention;

FIG. 4 is a schematic view illustrating the service of device in the first preferred embodiment of this invention;

FIG. 5 is a circuit block diagram of another preferred embodiment of this invention; and

FIG. 6 is a schematic view illustrating the service of device in another preferred embodiment of this invention.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

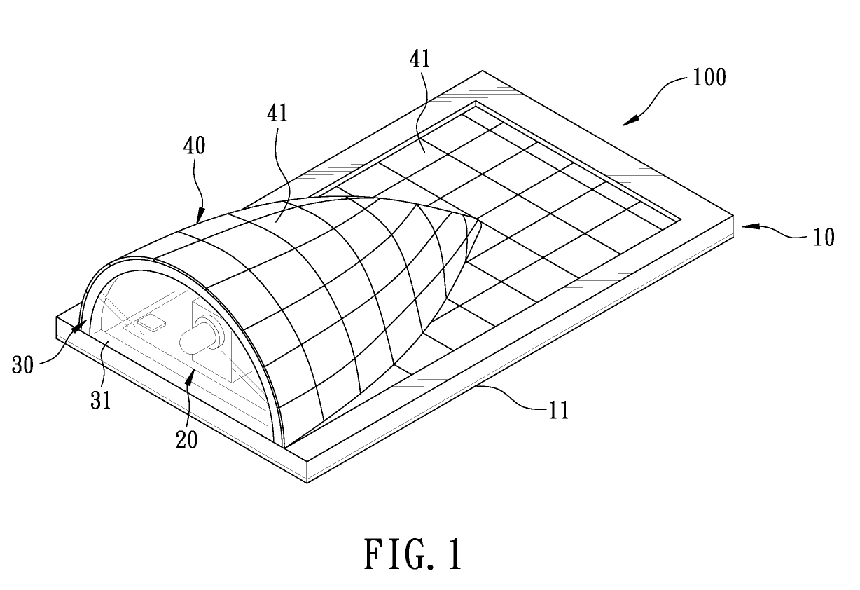

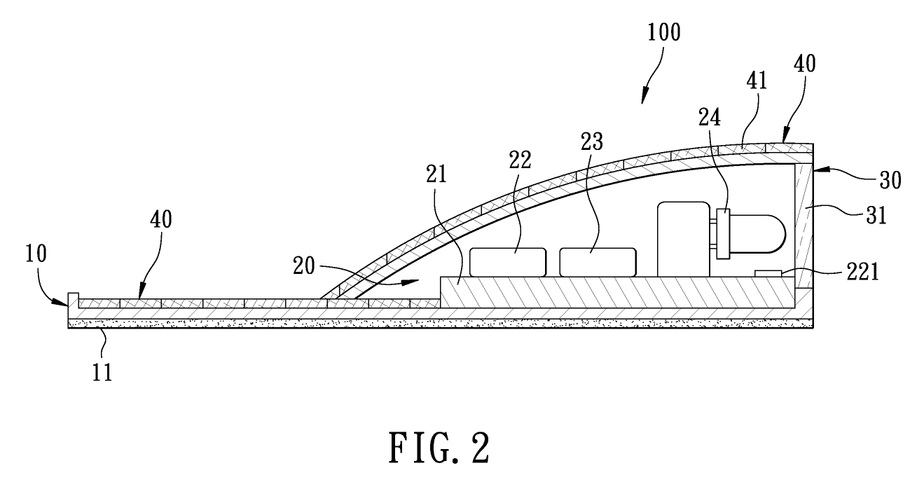

With reference to FIGS. 1 and 2 illustrating the unplugged night lights in a preferred embodiment of this invention, the unplugged night lights 100 mainly comprises a base 10, a light-emitting device 20, a housing 30, and a thin-film solar cell pack 40.

The base 10 is made of a flexible material, of which a bottom is coated with an adhesive layer 11.

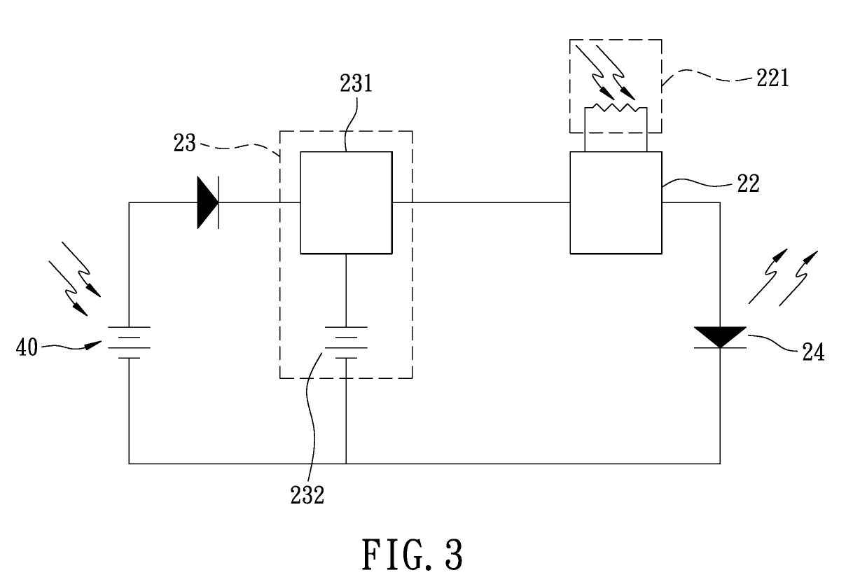

The light-emitting device 20 is provided on the base 10, mainly comprising a PCB 21 on which a control circuit unit 22, a power source unit 23, and a light-emitting source 24 are provided. One terminal of the control circuit unit 22 is connected to the light-emitting source 24 to control, in the preferred embodiment of this invention, the light-emitting source 24 is a light-emitting diode (LED), and the other terminal of the control circuit unit 22 is connected to the power source unit 23. The power source unit 23 further comprises a charging and discharging circuit 231 and a secondary cell 232 and supplies the electric energy to the light-emitting source 24 and stores the electric energy inputted externally. With reference to FIG. 3, in the preferred embodiment of this invention, the control circuit unit 22 further comprises a switching circuit 221 that is connected to a light sensitive resistor (LSR) to detect the intensity of a light source and send an enable signal to the control circuit unit 22 to automatically control the light source 24.

The housing 30 is provided on the base 10 and wraps around the light-emitting device 20. The housing 30 is further provided with a translucent portion 31 from which the light source generated by the light-emitting source 24 in the light-emitting device 20 is transmitted.

The thin-film solar cell pack 40 and the housing 30 are arranged together at a side of the base 10. The thin-film solar cell pack 40 is mainly made up with a plurality of flexible semiconductor photoelectric chip 41 and one terminal of the thin-film solar cell pack 40 is electrically connected to the charging and discharging circuit 231 of the power source unit 23 of light-emitting device 20.

In order to further make apparent the structural features, applied skill and manners, and expected effects according to this invention, what are applied in this invention are in detail described, and it is thus believed that this invention is thoroughly and concretely apparent, as described below.

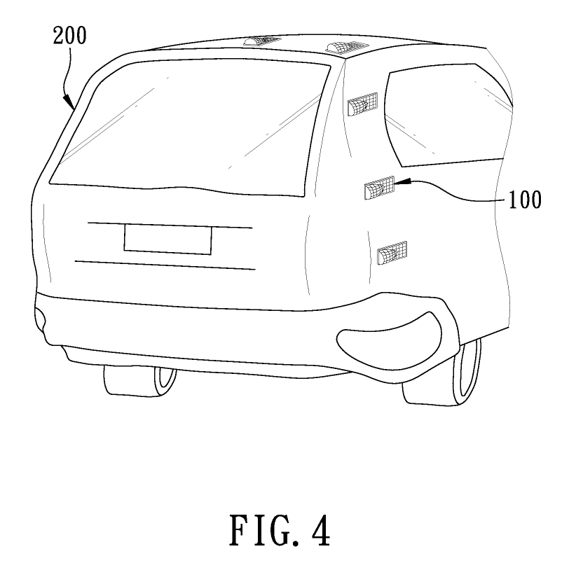

With reference to FIGS. 3 and 4, before being used, the unplugged night lights 100 adheres with the adhesive layer 11 on the base 10 to the vehicle body 200. When the light source is sufficient, the unplugged night lights 100 uses the thin-film solar cell pack 40 to absorb the light energy, transforms the absorbed light energy into the electric energy, and uses the charging and discharging circuit 231 of the power source unit 23 to store the electric energy in the secondary cell 232 connected to the other terminal of the charging and discharging circuit 231. When detecting a weak light source from outside, the light sensitive resistor connected to the switching circuit 221 of the control circuit unit 22 sends an enable signal to the control circuit unit 22, making the control circuit unit 22 control the charging and discharging circuit 231 of the power source unit 23 and thus making the charging and discharging circuit 231 supply the electric energy stored in the secondary cell 232 to the control circuit unit 22. The control circuit unit 22 controls the light-emitting source 24 thus yielding the light source, and then the light source is transmitted from the transparent portion 31 of the housing 30.

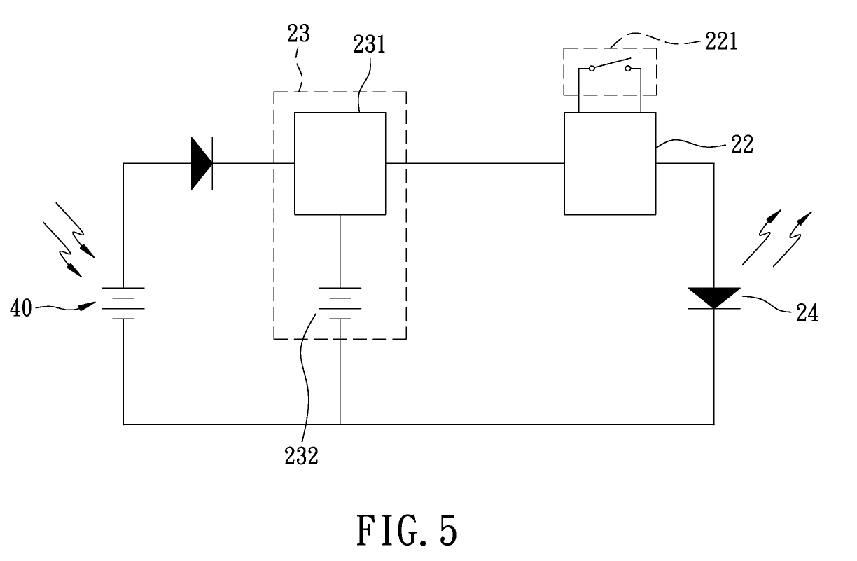

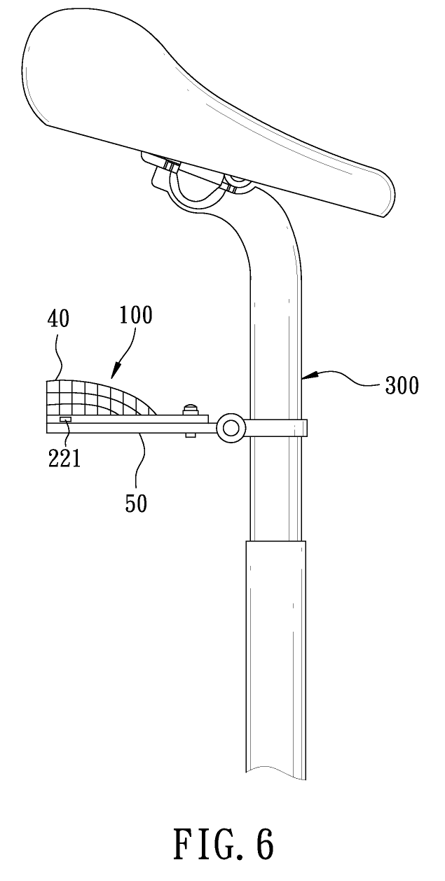

With reference to FIGS. 5 and 6 illustrating the unplugged night lights 100 in another embodiment of this invention, the major structure and effect in the embodiment is the same as that in the previous preferred embodiment, so unnecessary details are not given here. The base 10 of the unplugged night lights 100 is locked into a mounting bracket 50 that is fixed onto a rod 300 of a bicycle, and the switching circuit 221 is a mechanical switch. Thus, when the light source is sufficient, the unplugged night lights 100 uses the thin-film solar cell pack 40 to transform the light energy into the electric energy and stores it in the secondary cell 232 of the power source unit 23; when a user manually switches ON the switching circuit 221, the charging and discharging circuit 231 of the power source unit 23 controls the secondary cell 232 supplying the electric energy to the light-emitting source 24 to produce the light source.

Further, the light-emitting source 24 in the unplugged night lights 100 according to this invention may be connected to a fiber-optic lead wire (not shown). An illuminating portion is provided at another terminal of the fiber-optic lead wire so that the unplugged night lights 100 may give out the light source of different colors through the light-emitting source 24 and then transmit the light to the illuminating portion through the fiber-optic lead wire, thereby giving out the light source. The unplugged night lights 100 thereby may not only give out the light sources of various colors, but also match with the fiber-optic lead wires in different sizes to meet various requirements of luminance. With the adhesive layer 11 of the base 10, the unplugged night lights further adheres to a required site or is mounted outdoors or indoors as a decorate matching with different mounting brackets 70.

Here, the features and attainable expected effects of this invention are described again below.
1. The base of unplugged night lights according to this invention and the thin-film solar cell pack are flexible so as to be arranged on a random plane, not only offering extra required light source but also being easily installed.
2. The unplugged night lights according to this invention is not only electrically connected to a battery jar in the vehicle by using no electrical wire, but also arranged at a random position of the object bodies and the unplugged night lights gives out the light source transformed from the electric energy stored, thereby being easily installed and effective in environmental protection and energy saving.
3. The unplugged night lights according to this invention uses the thin-film solar cell pack to transform the light energy into the electric energy and then stores it and supplies the stored electric energy to the light-emitting source to give out another light source for the effect of energy saving.

To sum up, from the disclosed art, this invention may provide a design widely different from the conventional design, which increases the entire use value, and further this invention is indeed unprecedented and has not been published and not similar to any other product in the market, so it completely meets the requirements of application for the patent. We earnestly request that this application be examined in detail and approved as soon as possible for protection of the inventor's rights and interests. Please feel free to contact us if you, the examiner, have any questions at the time of examination.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. The unplugged night lights, mainly comprising:
a base being made of a soft material and thus being flexible;
a light-emitting device provided on the base, mainly comprising a PCB on which a control circuit unit, a power source unit, and a light-emitting source are provided, in which one terminal of the control circuit unit is connected to the light-emitting source to control, and the other terminal of the control circuit unit is connected to the power source unit supplying electric energy to the light-emitting source and depositing the electric energy inputted externally;
a housing being provided on the base, wrapping around the light-emitting device and being provided with a translucent portion from which the light source generated by the light-emitting source in the light-emitting device is transmitted;
a thin-film solar cell pack being arranged together with and the housing at a side of the base and being mainly made up with a plurality of flexible semiconductor photoelectric chip, in which the thin-film solar cell pack first transforms a light energy into an electric energy and then transmits the electric energy to the power source unit of light-emitting device connected to one terminal so that the light-emitting device may store the electric energy in the power source unit.

2. The unplugged night lights, according to claim 1, wherein a bottom of the base is coated with an adhesive layer adhering to a random surface.

3. The unplugged night lights, according to claim 1, wherein the control circuit unit further comprises a switching circuit.

4. The unplugged night lights, according to claim 3, wherein the switching circuit mainly comprises a light sensitive resistor that detects the intensity of light source and sends an enable signal to the control circuit unit to automatically control the light source.

5. The unplugged night lights, according to claim 3, wherein the switching circuit mainly comprises a mechanical switch that manually controls the control circuit unit switching ON or OFF the light-emitting source.

6. The unplugged night lights, according to claim 1, wherein the light-emitting source is a light-emitting diode (LED).

7. The unplugged night lights, according to claim 1, wherein the light-emitting source is connected to a fiber-optic lead wire of which the other terminal is provided with an illuminating portion.

8. The unplugged night lights, according to claim 1, wherein the power source unit further comprises a charging and discharging circuit and a secondary cell.
